(19) United States
(12) Patent Application Publication
(10) Pub. No.: US 2026/0077347 A1
(43) Pub. Date: Mar. 19, 2026

(54) BIOMEDICAL DETECTION CHIP

(71) Applicant: National Tsing Hua University, Hsinchu City (TW)

(72) Inventors: Chih-Yung HSU, Hsinchu City (TW); Cheng-Hsien LIU, Hsinchu City (TW)

(21) Appl. No.: 18/911,608

(22) Filed: Oct. 10, 2024

(30) Foreign Application Priority Data
Sep. 13, 2024 (TW) 113134812

(51) Int. Cl. B01L 3/00

(52) U.S. Cl. CPC B01L 3/502715; B01L 2200/027; B01L 2300/0645; B01L 2300/0819; B01L 2300/0864; B01L 2300/087; B01L 2300/0883

(57) ABSTRACT

A biomedical detection chip includes a detection module including a detection substrate, an input distribution unit, and flow channel units. The input distribution unit has a distribution component disposed in the detection substrate that has a receiving opening and outlets, and allowing a liquid that enters from the receiving opening to be Gaussian distributed and flow out from the outlets. The flow channel units respectively communicate with the outlets. Each of the flow channel units has a first flow channel part and a second flow channel part. The first flow channel part includes a first flow channel and a first chamber located in the detection substrate. The second flow channel part includes a second flow channel and a second chamber located in the detection substrate. Through the input distribution unit cooperating with the flow channel units, simultaneously testing effects of drugs on different concentrations of a targeted cell is achieved.

### CROSS-REFERENCE TO RELATED APPLICATION

This application claims priority to Taiwanese Invention Patent Application No. 113134812, filed on Sep. 13, 2024, the entire disclosure of which is incorporated by reference herein.

### FIELD

The present invention is related to a detection chip, and more particularly to a biomedical detection chip for cell testing.

### BACKGROUND PRIOR ART

In recent years, treatment of cancer has been continuously advancing. The emergence of different medical techniques, from conventional surgeries, chemotherapies, radiotherapies to current immunotherapies and targeted drug therapies, has the medical recovery rate of current patients increase.

Due to differences between bodies of different patients, there are gaps between the effects generated by drugs on different patients. As a result, designs of drugs for different patients are extremely complicated. In addition, conventional drug experiments are usually time-consuming in cultivating tissues and require massive testing doses. Moreover, expenditure of constant treatments may also bring a considerable burden on financial conditions of patients themselves. Therefore, how to simultaneously test the effects of a drug on a cancer cell under different conditions to thereby reducing a drug testing time period is a critical issue.

### SUMMARY

Therefore, an object of the present invention is to provide a biomedical detection chip that can simultaneously test effects of drugs on different concentrations of a cancer cell.

Thus, the biomedical detection chip of the present invention includes a detection module.

The detection module includes a detection substrate, an input distribution unit and a plurality of flow channel units.

The input distribution unit has a distribution component that is disposed in the detection substrate and a first inlet that is formed downwardly from a surface of the detection substrate. The distribution component has a receiving opening and a plurality of outlets that are located at an end opposite to the receiving opening. The first inlet communicates with the receiving opening. The distribution component is configured for allowing a liquid that enters from the receiving opening to be Gaussian distributed and to flow out from the outlets.

The flow channel units respectively communicate with the outlets of the distribution component. Each of the flow channel units has a first flow channel part and a second flow channel part.

The first flow channel part includes a first flow channel that is located in the detection substrate and a first chamber that is located downstream of the first flow channel. An end of the first flow channel communicates with the respective one of the outlets. Another end of the first flow channel communicates with an end of the first chamber.

The second flow channel part includes a second inlet and an opening that are separately and downwardly formed from the surface of the detection substrate, a second flow channel that is located in the detection substrate, and a second chamber that is located in the detection substrate and that is adjacent to the first chamber. An end of the second flow channel communicates with the opening, and another end thereof communicates with an end of the second chamber. Another end of the second chamber communicates with the second inlet. Another end of the first chamber communicates with the another end of the second flow channel.

The first chamber and the second chamber are between the opening and the second inlet. The first chamber and the second chamber communicate with each other.

The effect of this invention lies in that: through the distribution component of the detection module, stromal cells that are injected into the detection substrate can be automatically distributed into the first chambers with different contents. In addition, in cooperation with communication of each of the first chambers with a respective one of the second chambers, the contents of the cancer cells in the second chambers are different due to the stromal cells in the first chambers, thereby achieving the effect of simultaneously testing impacts of drugs on different concentrations of the cancer cell.

### BRIEF DESCRIPTION OF THE DRAWINGS

Other features and effects of this invention will be clearly presented in the embodying manners with reference to the drawings, in which:

FIG. 1 is a perspective exploded view of an embodiment of a biomedical detection chip of the present invention;

FIG. 2 is a top view of the embodiment, illustrating a detection module of the embodiment;

FIG. 3 is a fragmentary enlarged view of the embodiment, illustrating a connecting status between a first chamber and the second chamber of the embodiment;

FIG. 4 is a top view of the embodiment, illustrating an electrode module of the embodiment; and

FIG. 5 is a top view of the embodiment, illustrating a feeding module of the embodiment.

### DETAILED DESCRIPTION

Before the present invention is described in detail, it should be noted that similar elements are represented by the same reference numeral in the following description.

Regarding the relevant technical contents, features, and effects of the present invention, they will be clearly presented in the following detailed description of the embodiments with reference to the drawings. In addition, it should be noted that the drawings of the present invention merely indicate the structural and/or positional relative relationship(s) among the components, and are not relevant to the actual size of each component.

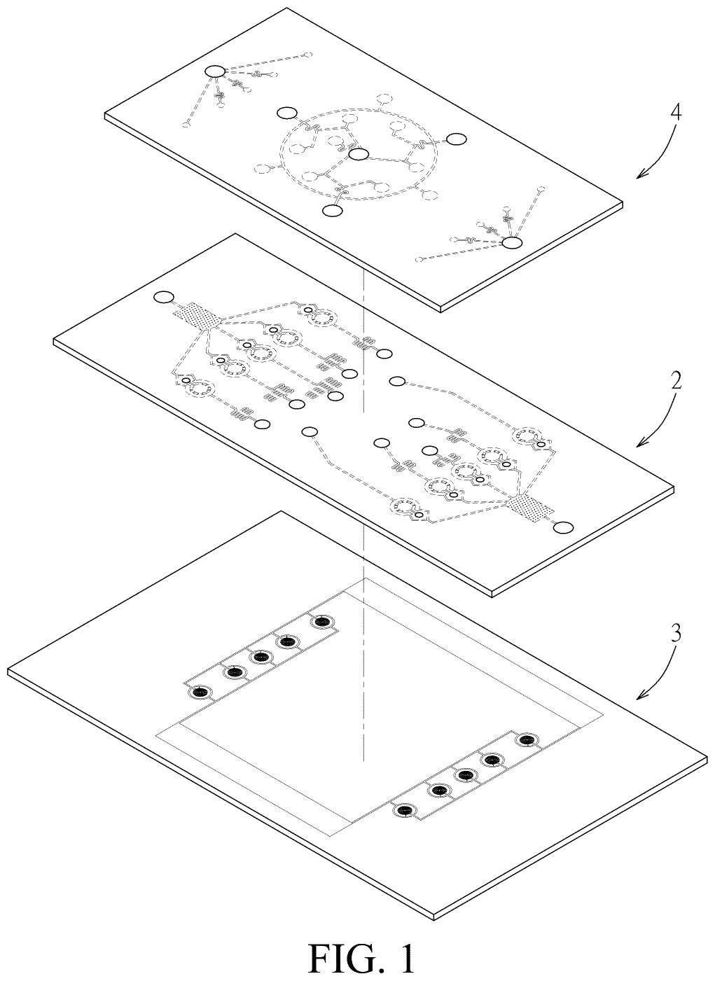

Referring to FIG. 1, an embodiment of the biomedical detection chip of the present invention includes a detection module 2, an electrode module 3 and a feeding module 4.

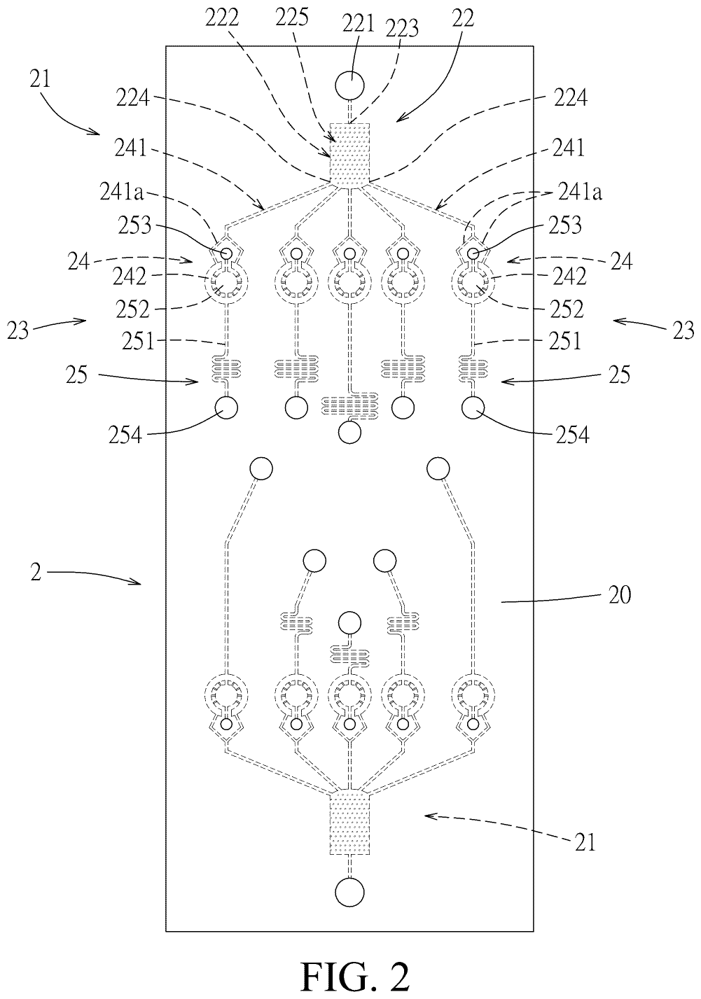

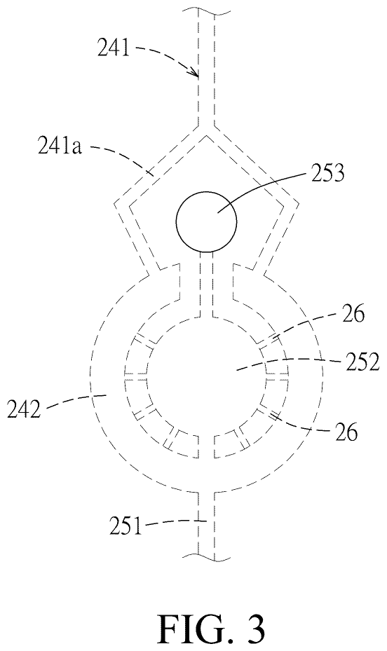

Referring further to FIG. 2 and FIG. 3, the detection module 2 includes a detection substrate 20 and two detection structures 21 that are disposed opposite to each other.

Each of the detection structures 21 includes an input distribution unit 22 and a plurality of flow channel units 23. The input distribution unit 22 has a first inlet 221 that is formed downwardly from a surface of the detection substrate 20 and a distribution component 222 that is disposed in the detection substrate 20. The distribution component 222 has a receiving opening 223, a plurality of outlets 224 that are located at an end opposite to the receiving opening 223, and a Gaussian distribution structure 225 that is between the receiving opening 223 and the outlets 224. The first inlet 221 communicates with the receiving opening 223. The Gaussian distribution structure 225 is formed by a plurality of slender poles arranged in a predetermined array, and is configured for allowing a liquid that enters from the receiving opening 223 to be Gaussian distributed and to flow out from the outlets 224. Since the Gaussian distribution structure 225 is well-known for a person having ordinary skill in this art, the detailed structure thereof is not going to be discussed herein.

The flow channel units 23 respectively communicate with the outlets 224 of the distribution component 222. Each of the flow channel units 23 has a first flow channel part 24 and a second flow channel part 25.

The first flow channel part 24 includes a first flow channel 241 that is located in the detection substrate 20 and a first chamber 242 that is located downstream of the first flow channel 241. An end of the first flow channel 241 communicates with the respective one of the outlets 224. Another end of the first flow channel 241 communicates with one of ends of the first chamber 242.

The second flow channel part 25 includes a second flow channel 251, a second chamber 252, a plurality of micro-conduits 26 that are located in the detection substrate 20, and a second inlet 253 and an opening 254 that are formed downwardly from the surface of the detection substrate 20.

The first and second chambers 242, 252 are between the second inlet 253 and the opening 254, are adjacent to each other and communicate with each other through the micro-conduits 26. An end of the second flow channel 251 communicates with the opening 254, and another end thereof communicates with an end of the second chamber 252. Another end of the second chamber 252 communicates with the second inlet 253. Another end of the first chamber 242 communicates with the another end of the second flow channel 251.

In the present embodiment, the distribution component 222 of the input distribution unit 22 of each of the detection structures 21 has five of the outlets 224 and five of the flow channel units 23 that respectively communicate with the outlets 224. The first chamber 242 of each of the flow channel units 23 is ring-shaped and surrounds the second chamber 252 that is round-shaped. The end of the first flow channel 241, which communicates with the first chamber 242, is firstly divided into two branched channels 241a, and then communicates with the first chamber 242. The second inlet 253 is between the two branched channels 241a and the second chamber 252. An end of the first chamber 242 that is opposite to the first flow channel 241, and the another end of the second chamber 252 that is opposite to the first flow channel 241, are closely adjacent to and communicate with each other, and communicate with the second flow channel 251. The micro-conduits 26 are distributed at equiangular intervals. However, in other embodiments, there may be only one detection structure 21, and the number of elements the detection structure 21 has is not limited to such.

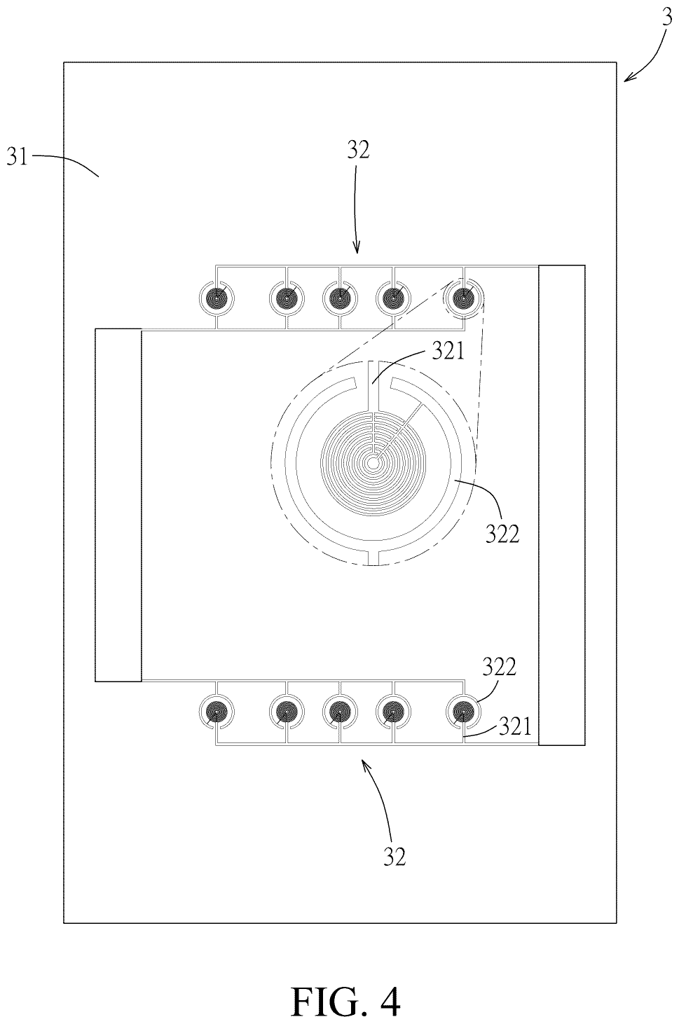

Referring to FIG. 4, the electrode module 3 is located under the detection module 2, and includes an electrode substrate 31 and a plurality of patterned electrode units 32 that are formed on a surface of the electrode substrate 31 and that correspond to the first chambers 242 and the second chambers 252. Each of the patterned electrode units 32 has a first electrode assembly 321 and a second electrode assembly 322 that are arranged in a predetermined pattern (the concentric pattern as illustrated in FIG. 4) and that are independent circuits, respectively.

In some embodiments, the first electrode assembly 321 and the second electrode assembly 322 may form circuit patterns having different densities. In addition, by virtue of current circuits that is generated by the circuit patterns forming uneven electric fields during electrification, cells that are located in the first chambers 242 and the second chambers 252 can be effectively trapped through dielectrophoresis forces. In addition, because of the circuit patterns that are different in density, the cells can be formed into specific patterns, which is beneficial to simulate an actual arranging situation of the cells.

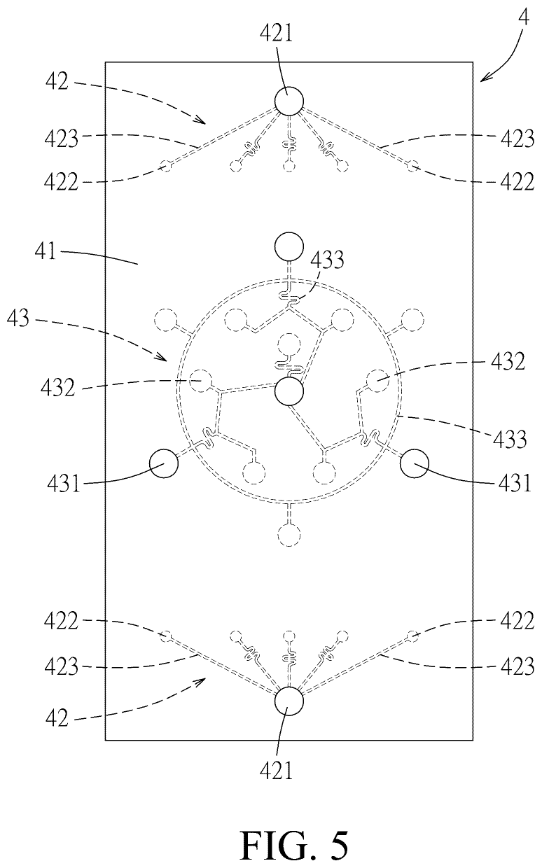

Referring further to FIG. 5, the feeding module 4 is located on the detection module 2, and includes a feeding substrate 41 that is connected to the detection substrate 20, a first feeding unit 42 that is formed in the feeding substrate 41 and that corresponds to and communicates with the second inlets 253 of the input distribution units 22, and a second feeding unit 43 that corresponds to and communicates with the openings 254 of the flow channel units 23.

The feeding substrate 41 has an upper surface and a lower surface that are opposite to each other. The first feeding unit 42 has a first input opening 421 that is formed downwardly from the upper surface of the feeding substrate 41, a plurality of first output openings 422 that are formed from the lower surface of the feeding substrate 41 in a direction toward the upper surface, and a plurality of first communication flow channels 423 that are located in the feeding substrate 41 and that respectively communicate the first output openings 422 with the first input opening 421. The second feeding unit 43 has at least one second input opening 431 that is formed downwardly from the upper surface of the feeding substrate 41, a plurality of second output openings 432 that are formed from the lower surface of the feeding substrate 41 in a direction toward the upper surface, and a plurality of second communication flow channels 433 that are located in the feeding substrate 41 and that communicate with each of the second input opening 431 and the second output openings 432. The first output openings 422 respectively correspond to and communicate with the second inlets 253, and the second output openings 432 respectively correspond to and communicate with the openings 254.

Specifically, in the present embodiment, the first feeding units 42 respectively correspond to the detection structures 21. Each of the first feeding units 42 has the first input opening 421 that is formed downwardly from the upper surface of the feeding substrate 41, five of the first output openings 422 that correspond to the first input opening 421, and five of the first communication flow channels 423 that are located in the feeding substrate 41 and that correspondingly communicate each of the first input openings 421 with the first output openings 422. The second feeding unit 43 has four of the second input openings 431 and ten of the second output openings 432 that are formed downwardly from the feeding substrate 41, and a plurality of second communication flow channels 433 that are located in the feeding substrate 41 for communicating with the second input openings 431 and the second output openings 432. Five of the first output openings 422, to which each of the first input openings 421 corresponds, respectively correspond to and communicate with the second inlets 253 of each of the detection structures 21. In addition, the ten second output openings 432 respectively correspond to and communicate with the openings 254 of two of the detection structures 21. However, in other embodiments, numbers thereof are not limited to the abovementioned.

The detection module 20 and the feeding substrate 41 may be made of a soft silicone rubber material that has bio-compatibility. Each of the first communication flow channels 423 is the same in length and each of the second flow channels 251 is the same in length, so that flow drags generated by liquids that flow through the first communication flow channels 423 and the second flow channels 251 are the same. In addition, at least a portion of the first communication flow channels 423 and the second flow channels 251 is zigzag-shaped, and thereby it is beneficial to extend a time period for which the liquids flow to the first chambers 242 and the second chambers 252, and is beneficial to increase the degree of evenness of a mixture of different liquids.

When the biomedical detection chip of the present invention is used for performing tests, firstly, a hydrogel solution, which contains stromal cells and which is light-curable, is perfused from the two first inlets 221 into the corresponding distribution components 222. Through the distribution components 222, the solution forms a plurality of branched solutions (each of the distribution components 222 illustrated in FIG. 1 is to distribute the hydrogel solution into five branched solutions with different concentration distributions) that are in a Gaussian distribution ratio (normal distribution), and through the outlets 224, the branched solutions respectively enter into the first flow channels 241, and eventually stop and stay in the first chambers 242, thereby perfusion of the stromal cells being accomplished.

Next, after a hydrogel solution containing cancer cells is injected into the two first input openings 421, five even branches are separately formed and correspondingly flow into the first communication flow channels 423, and after flowing out from the first output openings 422, the branches flow into the second chambers 252 from the second inlets 253 that correspond to and communicate with the second chambers 252. Since the first chambers 242 respectively communicate with the second chambers 252 through the micro-conduits 26, and since concentrations of the stromal cell in the first chambers 242 are in normal distribution, environments having different concentrations of the cancer cell may be formed between each of the first chambers 242 and the respective second chamber 252.

Hydrogels contain a polymer that is bio-compatible and a chemical compound that is used for light curing to crosslink with the polymer.

When the perfusion of the cells of the first chamber 242 and the second chamber 252 are all accomplished, ultraviolet light is used for curing the hydrogels so that construction of cytoskeletons is accomplished.

After the construction of the cytoskeletons is accomplished, four different types of sampling drugs can be respectively added into the four second input openings 431. The four different types of sampling drugs, after flowing through the second communication flow channels 433 and being evenly mixed to form ten different groups of drug-combinations, flow into the openings 254 of the two detection structures 21 of the detection module 2 respectively through the ten second output openings 432, thereby injection and distribution of the drugs being accomplished.

Each type of the drug correspondingly enters into the first chamber 242 and the second chamber 252 through one of the second flow channel 251 from the respective opening 254, so that the stromal cells in the first chamber 242 and the cancer cells in the second chamber 252 are kept in the environments that are filled with the drug, to thereby observe effects of the drug-combinations on the cells.

It should be noted that before the ultraviolet light is used, through each of the first electrode assemblies 321 and a corresponding second electrode assembly 322 of the electrode module 3 being electrified, and through uneven electric fields generated between the first electrode assemblies 321 and the corresponding second electrode assemblies 322, the stromal cells in the first chamber 242 and the cancer cells in the second chambers 252 can be arranged evenly in a specific manner, so as to more precisely restore the microenvironment of the cancer tumor cell.

In some embodiments, the biomedical detection chip may not need to be equipped with the electrode module 3 according to requirements.

In summary, in the biomedical detection chip of the present invention, through designs of the distribution component 222, the first chamber 242, and the second chamber 252 and further cooperating with the first feeding unit 42 and the second feeding unit 43, the device can simultaneously and easily perform arrangement for environments having different concentrations of the cancer cell, thereby testing effects of different types of drug-combinations on the environments having different concentrations of the cancer cell. Therefore, the object of the present invention can be achieved indeed.

However, the above-mentioned are merely embodiments of this invention and should not be used to limit the practicing scope of this invention. Any simple equivalent variations and modifications made in accordance with the claims and the content of the specification of this invention shall still fall within the scope covered by the claims of the present invention.

What is claimed is:

1. A biomedical detection chip, comprising:
a detection module including a detection substrate, an input distribution unit, and a plurality of flow channel units,
wherein said input distribution unit has a distribution component that is disposed in said detection substrate and a first inlet that is formed downwardly from a surface of said detection substrate, said distribution component having a receiving opening and a plurality of outlets that are located at an end opposite to said receiving opening, said first inlet communicating with said receiving opening, said distribution component being configured for allowing a liquid that enters from said receiving opening to be Gaussian distributed and flow out from said outlets; and
wherein said flow channel units respectively communicate with said outlets of said distribution component, each of said flow channel units having a first flow channel part and a second flow channel part, said first flow channel part including a first flow channel that is located in said detection substrate and a first chamber that is located downstream of said first flow channel, an end of said first flow channel communicating with the respective one of said outlets, another end of said first flow channel communicating with an end of said first chamber, said second flow channel part including a second inlet and an opening that are separately and downwardly formed from said surface of said detection substrate, a second flow channel that is located in said detection substrate, and a second chamber that is located in said detection substrate and is adjacent to said first chamber, an end of said second flow channel communicating with said opening, another end communicating with an end of said second chamber, another end of said second chamber communicating with said second inlet, another end of said first chamber communicating with said another end of said second flow channel,
said first and second chambers being between said opening and said second inlet, said first chamber and said second chamber communicating with each other.

2. The biomedical detection chip as claimed in claim 1, wherein said first chamber is ring-shaped, said second chamber is round-shaped, and said first chamber surrounds said second chamber.

3. The biomedical detection chip as claimed in claim 2, wherein said detection module further includes a plurality of micro-conduits that are located in said detection substrate, and said micro-conduits communicate with said first chamber and said second chamber.

4. The biomedical detection chip as claimed in claim 1, further comprising a feeding module, said feeding module including a feeding substrate, a first feeding unit that is formed in said feeding substrate, and a second feeding unit, said first feeding unit communicating with said second inlets of said detection module, said second feeding unit communicating with said openings of said detection module.

5. The biomedical detection chip as claimed in claim 4, wherein said feeding substrate has an upper surface and a lower surface that are opposite to each other, said first feeding unit having a first input opening that is formed downwardly from said upper surface of said feeding substrate, a plurality of first output openings that are formed from said lower surface of said feeding substrate in a direction toward said upper surface, and a plurality of first communication flow channels that are located in said feeding substrate and that respectively communicate said first output openings with said first input opening, said second feeding unit having at least one second input opening that is formed downwardly from said upper surface of said feeding substrate, a plurality of second output openings, and a plurality of second communication flow channels that are located in said feeding substrate and that communicate with each of said at least one second input opening and said second output openings, said first output openings respectively corresponding to and communicating with said second inlets, said second output openings respectively corresponding to and communicating with said openings.

6. The biomedical detection chip as claimed in claim 5, wherein said at least one second input opening includes a plurality of second input openings, said second communication flow channels communicating with said second input openings and said second output openings.

7. The biomedical detection chip as claimed in claim 5, wherein each of said first communication flow channels is same in length and each of said second flow channels is same in length.

8. The biomedical detection chip as claimed in claim 1, further comprising an electrode module that is located under said detection module, said electrode module including an electrode substrate and a plurality of patterned electrode units that are formed on a surface of said electrode substrate and that correspond to said first chambers and said second chambers, each of said patterned electrode units having a first electrode assembly and a second electrode assembly that are arranged in a predetermined pattern and that are independent circuits.

9. The biomedical detection chip as claimed in claim 8, wherein said first electrode assembly and said second electrode assembly has a concentric structure with different densities.
